(19) United States
(12) Patent Application Publication
(10) Pub. No.: US 2010/0321280 A1
(43) Pub. Date: Dec. 23, 2010

(54) Display

(76) Inventor: Michael Sigmund, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/815,652

(22) Filed: Jun. 15, 2010

(30) Foreign Application Priority Data
Jun. 18, 2009 (DE) 10 2009 025 483.8

(51) Int. Cl. G09G 3/30; G09G 3/36

(52) U.S. Cl. 345/76; 345/87; 345/102

(57) ABSTRACT

A display having a display plane comprising individual pixel elements is proposed. The display can be controlled pixel by pixel by way of an array comprising control elements, with a sensor plane comprising individual photo diodes, which can be read out line by line by way of a readout circuit, being provided, which is used to scan the surface of a flat object adjacent to the display.

### CROSS REFERENCE TO RELATED APPLICATIONS

This application claims priority of German application No. 10 2009 025 483.8 filed Jun. 18, 2009, which is incorporated by reference herein in its entirety.

### FIELD OF THE INVENTION

The invention relates to a display with a display plane comprising individual pixel elements, which can be controlled pixel by pixel by way of an array comprising control elements.

### BACKGROUND OF THE INVENTION

Displays of this type, frequently also known as flat screens, are used to display images or other information and are used in various embodiments. Smaller displays are known in mobile telephones or PDAs or other portable data carriers, or screens of PCs or laptops etc. Such a display or such a screen is embodied for instance as a liquid crystal display (LCD). In terms of functional principle, an illumination facility is provided to generate a background light, the light is injected from the rear onto a display plane, on its front side, usually covered by a transparent screen, the images or information to be displayed can be visualized. This display plane is embodied as a pixel matrix comprising a plurality of individual liquid crystal cells. A liquid crystal molecule layer is disposed between two substrate plates with corresponding electrode arrangements, the substrate plates also comprise polarization filters, in order to rotate the injected light. As a function of the electrical voltage applied to the individual pixel electrodes, an electrical field is formed, which effects a rotation of the liquid crystal molecules, so that the polarization of the light is varied. To control the individual pixels or in order to influence the applied electrical voltage, an array comprising control elements is used, conventionally an array comprising thin film transistors (TFT). In this example, mention is made of active matrix displays, the control elements form active components. With such active matrix displays, when addressing and controlling by way of the transistor matrix, the image element is charged at the time of addressing, whereby a storage capacitor is usually arranged in parallel thereto. The applied charge corresponds to the level of data information. After applying the charge, the active component, here the transistor, is switched back into the high-resistance state, as a result of which the charge and thus the control essentially remain during an image period. This results in a more effective voltage across the pixel, with the result that a higher control of the liquid crystal of the pixel and thus an improved contrast and a reduced dependency of the contrast on the observation direction ensues. The basic design and functionality of such an LCD display are known sufficiently and need not be described in more detail.

Alternatively to the use of LCD displays, OLED displays (organic light emitting diode) are also used for instance. Diodes made of organic, semi-conductive materials are used here as imaging, pixel-imaging elements. The OLEDs are made of several organic layers. In the organic semi-conductive material layer, electrons are injected by way of the cathodes, and the anode prepares the holes. Recombinations result within the layer, from which recombination processes, photons result and/or are emitted, with the color of the emitted light depending on the energy state between the excited state and the basic state. A background illumination is not needed in an OLED display. The functionality and design of such an OLED display are known and need not be explained in further detail.

### SUMMARY OF THE INVENTION

The invention basically covers all types of flat screen, irrespective of the afore-described examples in the form of LCD displays or OLED displays.

The exclusive function of such displays is to display the information provided by an information medium such as a storage device of a mobile telephone or a computer or any other source for instance across its display or visible surface.

The object underlying the invention is thus to improve the functionality of a display.

To solve this problem, provision is made in a display of the type cited in the introduction for a sensor plane comprising individual photo diodes, which can be read out line by line by way of a read-out circuit, said sensor plane being used to scan the surface of a flat object adjacent to the display.

The inventive display is characterized by an additional sensor plane, which is detailed further below and can be integrated in a different fashion. This sensor plane consists of an array of photo diodes, preferably aSi photo diodes. Contrary to the LCD cells or the OLED cells for instance, which each emit light in the case of a corresponding electrical control, a photo diode converts incident light into an electrical signal. If a flat object is now placed on the inventive display and/or its display surface, for instance a visitor card or a sheet of paper depending on the size of the display, it is therefore possible to illuminate the object placed thereupon by way of the display itself, on the other hand the reflection light reflected by the object can be received by way of the photo diode sensor plane and can be converted into electrical charge or signals in the individual photo diodes. This photo diode array can be read out line by line following a scanning process, i.e. the charges or signals located therein are read out by way of the read-out circuit and can be stored as image data in a control facility or suchlike arranged downstream thereof. The information relating to the object is thus scanned in electronically. It can be easily reproduced on the display itself or can be stored on a data carrier or transmitted to another, as is knowingly possible with data of this type.

The inventive display is thus multifunctional, it can be used on the one hand as a display for reproducing information, but on the other hand it can also be used as a scanner, just by the advantageous inventive integration of the sensor plane adjacent to the corresponding read-out circuit. The sensor plane can naturally be integrated such that on the one hand the display plane, or the pixels thereof, is not influenced or is only insignificantly influenced in terms of its imaging output by way of the integrated sensor plane, on the other hand, the sensor plane is integrated such that an adequately good resolution of the scanner result can still be achieved.

According to a first embodiment of the invention, the sensor plane can to this end be placed on the display plane and be at least partially transparent for light emitted by the display plane. An almost sandwich-type structure is therefore used here, in which the sensor plane with the photo diode matrix is placed on the display plane, in other words the LCD cell plane. The sensor plane can naturally be designed or the individual diodes configured and bound here in a corresponding carrier material such that the sensor plane is highly transparent for the light emitted by the LCD of OLED plane, thereby not resulting in any large shading effects and the information to be imaged by way of the display plane can still be visualized better. An adhesive layer can be used to fix the sensor plane for instance, by way of which the sensor plane is adhered to the display plane.

One alternative to mounting the sensor plane involves integrating the sensor plane into the plane containing the array comprising control elements, with the display plane for light reflected by the object being at least partially transparent. With this embodiment of the invention, the display plane is located in front of the sensor plane, which is integrated into the plane of the control elements. To ensure that sufficient reflected light reaches the sensor plane from the object during the scanning process, the LCD or OLED cell plane must in this case be sufficiently transparent for the reflected light. Whereas in the case of the previously described embodiment it is necessary to provide a separate readout circuit, since the sensor plane and the control element plane are separated, with this inventive embodiment, where the sensor plane is integrated into the control element plane, the control element plane can simultaneously serve as a readout circuit or form part of the latter. In other words, in the case of this integration in order to implement the readout circuit, the existing control circuit of the LCD or OLED display (or another control circuit if a different type of display is used) is used as a basis.

As already described, the display can be an LCD display, which originally includes an illumination facility for generating a background light. In terms of the functional principle of an LCD display, the background light is needed, since it is injected into the LCD plane from the rear and processed by way of the individual LCD pixel, in other words polarized and/or rotated accordingly, whereupon the individual color displays result pixel by pixel. This background light is used at the same time as a scanning light. If it is to be scanned for instance, a changeover into a corresponding scanning mode of the display takes place, whereupon only the light source of the LCD display is operated. The LCD display plane operates in this case such that the overall display only radiates white light, by way of which the object placed on the display surface is illuminated. The light reflected back by the object is then received by way of the sensor plane, exactly where this is (mounted or integrated in the control element plane) and is stored as electrical charge in the individual diodes, whereupon it is read out line by line.

In the case of an embodiment of a display as an OLED display, in which no background illumination is needed, the object illumination is performed by way of the OLED plane itself, i.e. the individual OLED pixels are controlled accordingly so that the mounted object is illuminated homogenously by way of the display surface. Here the mounted sensor array also receives the back-reflected light and stores this as a charge, which can then be read out line by line.

### BRIEF DESCRIPTION OF THE DRAWINGS

Further advantages, features and details of the invention result from the exemplary embodiments described below and with reference to the drawing, in which;

FIG. 1 shows a basic diagram of an inventive display in the form of a partial view according to a first embodiment,

FIG. 2 shows a basic diagram of an inventive display in the form of a partial view according to a second embodiment, and

FIG. 3 shows a basic diagram of an inventive display in the form of a partial view according to a third embodiment.

### DETAILED DESCRIPTION OF THE INVENTION

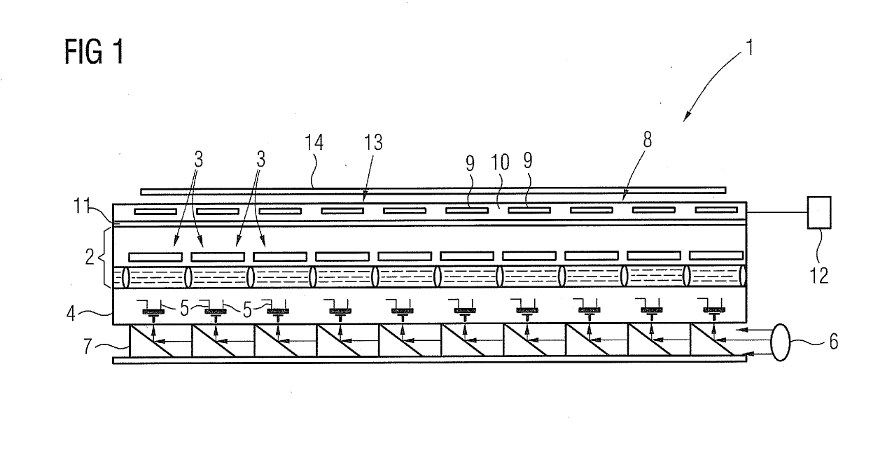

FIG. 1 shows a basic diagram of an inventive display 1 as claimed in a first embodiment. In this, only the central display parts are shown for reasons of clarity.

The display 1 shown is an LCD display with a display plane 2 consisting of a plurality of individual LCD cells 3, which each form individual pixels. The design of such an LCD display plane is known sufficiently to the person skilled in the art, reference need not be made in more detail hereto.

A further plane 4 comprising a plurality of individual control elements 5, which are thin film transistors arranged in the form of an array, are assigned to the display plane 2, with a thin film transistor in each case being used as an LCD pixel. This is therefore an active matrix display, with its function likewise being known. The individual transistors are naturally controlled by way of a corresponding circuit arrangement (not shown here), which is likewise sufficiently known.

A light source 6, which injects light into a reflection plane 7, is finally provided, in and/or by way of which the light injected from the side is deflected so that it passes through the control element plane 4 to the display plane 2 as background light, where it is polarized to varying degrees into the individual pixels depending on the alignment of the pixel by pixel liquid crystal, thereby resulting in the individual different pixel by pixel color displays. This design is also known sufficiently.

In the display 1 according to this invention embodiment, an additional sensor plane 8 comprising a plurality of individual photo diodes 9 arranged in the form of an array, said photo diodes 9 being received in a suitable mass or a suitable substrate 10, is now mounted to the known LCD structure by way of an adhesive layer 11. This sensor plane 8 or the individual photo diodes 9, usually aSi diodes, are read out line by line by way of a readout circuit 12, in order to acquire the charging information stored therein. The sensor plane 8 is used here to scan in information from a flat object placed on the display surface 13, which is now formed by the surface of the sensor plane 8 (or cover plate). To this end, after switching into a scan mode, the light source 8 is operated, the LCD display plane 2 is controlled by way of the control elements 5 such that white light is emitted by way of the overall plane. This passes through the sensor plane 8 and illuminates the object shown here 14 from below. The light reflected back by the object 14 is received by the photo diodes 9, converted into electrical charge and stored there. After terminating the scanning process, the photo diodes 9 are read out line by line in order to acquire the scanned information, which can then be further processed or stored or otherwise processed.

The embodiment of the sensor plane 8 is expediently such that it is as thin and highly transparent as possible, so that it results in as minimal a shading of the LCD display plane arranged therebelow as possible so that the information relating hereto which is shown in the conventional display operation can be easily acquired, i.e. the photo diodes 9 themselves are embodied as small as possible so that they do not have a negative optical effect, and the mass or the substrate 10 are also naturally transparent.

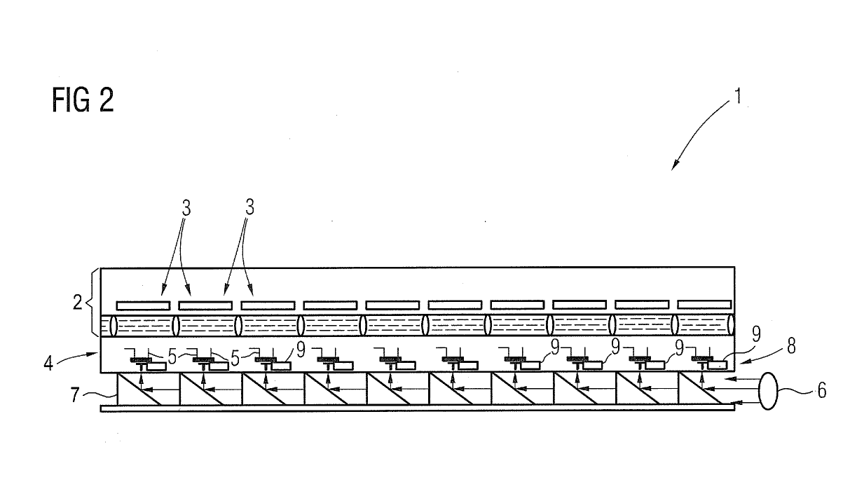

FIG. 2 shows a further inventive embodiment of a display 1, with the same reference characters being used for the same components as far as possible. A display plane 2 in the form of a pixel matrix made up of LCD cells is also used here, and the control element plane 4 is also provided here with the individual thin film transistors 5. The light source 6 and the reflection plane 7 are similarly provided.

Contrary to the embodiment as claimed in FIG. 1, the sensor plane 8 is however integrated into the control element plane 4, i.e. the individual photo diodes 9 are arranged in a distributed fashion in the control element plane 4, with a photo diode 9 being assigned, as shown, to each thin film transistor 5. The sensor element plane 8 is thus integrated here within the conventional LCD display structure, which is located below the actual LCD display plane. This is advantageous in that the same readout or control circuit can be used to read out the photo diode matrix line by line, i.e. that the thin film transistors 5 are part of this readout circuit or form same. No separate read-out circuit is therefore provided here as in the exemplary embodiment according to FIG. 1, instead, the control circuit of the LCD matrix is used in this type of integration.

In this embodiment of the invention, it is imperative that the thickness of the topmost layer, above which the LCD display surface is outwardly delimited, is as thin as possible, it should be less than 100 μm, in order to ensure the adequate transparency so that the light reflected back by the object mounted here (not shown in further detail) reaches the photo diodes 9 and achieves an adequately high resolution. This ensures here that the individual LCD pixel 3 only casts insignificant shade. Conversely, it is imperative that the photo diodes 9 are also as small as possible, so that they do not cast too much shade over the light radiated by way of the light source 6 and reflected to the LCD display plane 2.

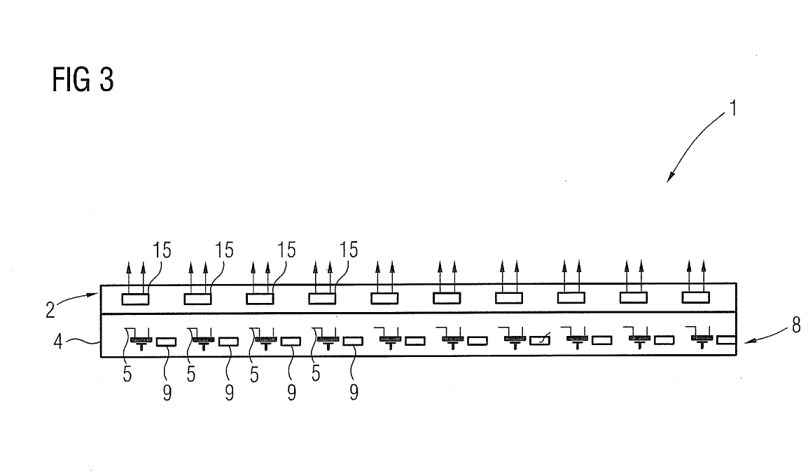

FIG. 3 finally shows an inventive display 1, in which the display plane 2 consists of a matrix comprising individual OLED cells 14, with the OLED cells 15 forming the individual pixels also in turn being controlled here by way of an individual control element in the form of thin film transistors 5 of a control element plane 4. In this embodiment, the individual photo diodes 9 of the sensor plane 8 are integrated into the control element plane 4, i.e. a photo diode 9 is assigned to each thin film transistor 5. The control element plane or its transistors are also used here to read out the photo diode matrix line by line. For scanning purposes, the display plane and/or the individual OLED cells 15 are controlled such that white light is emitted and a flat object (not shown in further detail), which is mounted on the topside, is illuminated. The reflection light is received in turn by the photo diodes 9 and then read out.

1.-7. (canceled)

8. A display, comprising:
a display plane comprising a plurality of individual pixel elements;
a control element plane comprising a plurality of individual control elements arranged in an array that controls the pixel elements pixel by pixel;
a readout circuit; and
a sensor plane comprising a plurality of individual photo diodes that can be read out by the readout circuit line by line to scan a surface of a flat object adjacent to the display.

9. The display as claimed in claim 8, wherein the sensor plane is placed on the display plane and is at least partially transparent for light emitted by the display plane.

10. The display as claimed in claim 9, wherein the sensor plane is adhered to the display plane by an adhesive layer.

11. The display as claimed in claim 8, wherein the sensor plane is integrated into the control element plane, and wherein the display plane is at least partially transparent for light reflected by the object.

12. The display as claimed in claim 11, wherein the readout circuit or a part of the readout circuit is formed by the control elements.

13. The display as claimed in claim 8, wherein a background light is generated by an LCD display with an illumination device.

14. The display as claimed in claim 8, wherein the display is an OLED display.
